(19) United States
(12) Patent Application Publication
(10) Pub. No.: US 2015/0242165 A1
(43) Pub. Date: Aug. 27, 2015

(54) Print transformation process and techniques for the purpose of providing enhanced printing capabilities including sequential and reverse printing formats.

(71) Applicant: James Michael Patock, SR., Fairfax, VA (US)

(72) Inventor: James Michael Patock, SR., Fairfax, VA (US)

(21) Appl. No.: 14/043,837

(22) Filed: Feb. 24, 2014

(51) Int. Cl. G06F 3/12

(52) U.S. Cl. CPC G06F 3/1219; G06F 3/1242; G06F 3/1206

(57) ABSTRACT

This document covers a printing system which is a modernization and transformation of the techniques and processes of document content and formatting as part of the control of printing. The transformation processes include all types of printers and documents.

It covers software to control the printing process and document transformation. This software will also transform the output of the print job into an output format that can be displayed in order to provide user interaction into the final printing process.

It also covers techniques and transformation processes to allow excerpts from other documents and e-books for the purpose of adding dependable reference information to printed documents to replace footnotes, endnotes and other cited information.

It includes several new printing formats that can improve the readability and production efficiency of documents. It includes copying printed sequential reverse format documents as well as copying other output from the printing system.

This patent application consists of a new way of controlling the printing of documents using a process and technique that handles documents and groups of documents in such a manner as to provide new formats, more efficient and less expensive methods of printing along with its associated costs (mailing and handling). It also provides security for information and references downloaded from the Internet or other locations by immediate printing of the references and documentation as part of the new processes and techniques of printing a document or documents. It also includes temporary storage of printable documents on a memory chip or hard drive connected to or integral to a printer as part of the printing process.

The new printing formats are a new method of printing and copying of the printed output of all types of documents, books, and newspapers. It should be noted this patent and patent concept covers the process and techniques in the form of concepts and ideas as well as outlines and flowcharts for its implementation and the generic code that will implement these concepts and ideas and processes and techniques.

This patent also covers copying printed pages or documents using Xerox machines or other techniques so as to produce documents that are copies of printed and bound sequential or reverse format in documents. The words print or printed in the context of this patent claim include not only the active printing process but copies that a produce essentially the same output document. The patent covers the result of the transformation and process as well as the transformation and process itself.

This patent covers transformations and procedures associated with the printing of an already completed document. It makes no attempt to modify the interior structure of the document or documents that is being printed under its control. Therefore it is clearly a complete new invention, technique, and process that does not have anything to do with already patented methods of creating new documents. The process and technique creates a print control job file that implements the commands of the operator in regard to what and how a document or documents is printed as well as implementing several new formats.

The code will be written in C++ and Java with C++ implementing internal programming and code with Java providing both the data input and the data output interface so as to provide maximum platform flexibility in a secure system. Due to the fact that much of the interface will be with printers and printer spoolers, Java developers may be requested to provide commands that are device specific so as to provide easy implementation for different printer platform/types or brands of printers.

Conceptually, while the patent covers a single overarching idea of controlling the processing of a print job that may contain one or more files, the process and technique can be separated into an visualized as three different concepts and processes.

The first section consists of a number of different printing formats fastened in such a way as to provide new and easier methods of reading documents, books and newspapers, and improvements in the efficiency and reductions in the cost of paper and printing and associated costs, primarily mailing and handling expenses.

The new formats introduce a sequential method of printing documents on computer-controlled printers, especially personal computers so that the first half of the document is printed in numeric sequence one side of one or more sheets of paper and the second half of the document is printed in reverse sequential order on the reverse side of the sheets of paper or papers.

Style A prints the second half of the document with the same sense as the first half and is fastened at either the top or the bottom which produces a document that is read in sequence on one side and then turned horizontally to continue reading in sequence on the second side while Style B prints the second half of the document with the opposite sense as the first half and is fastened at either the right or left side which produces a document that is read in sequence on one side and then flipped vertically to continue reading in sequence on the second side.

Both styles (A and B) and variations of them can be printed in either vertical portrait mode or and horizontal landscape mode which provides a variety of formats which is especially useful for printing and reading certain types of documents such as newspapers and magazines. Some documents such as newspapers and magazines can be printed on continuous sheets of paper in a fan fold format using either Style A or Style B which provide a completely different way of printing and reading newspapers and magazines.

The sequential reverse printing method provides an easy way to print random pages of a document or documents in a condensed format on both sides of printed sheets of paper. It provides a method of printing documents that potentially reduces the number of pages printed for a document or series or groups of documents by improving the methods available for two-sided printing.

The sequential reverse printing method (hereafter SRP) provides a method of printing documents that reduces the chances of operator error in the printing of two-sided documents and that this method of controlling the printing of a document or documents allows an operator or user to print pages or parts of pages of an input document or documents in any sequence so as to facilitate the creation of a single output document as specified by the user and using the minimum amount of paper.

The second part of the claim covers a process and technique that controls generation of printed documents in an entirely new manner by creating a print control file which allows the user to print the document or a series of documents as a print job controlled by the a print control file. The print job can be completely controlled as to what and how either entire documents or portions of documents can be printed so as to use the minimum amount of paper and ink for printing only the portions of the document desired by the user.

The software will create a print control file that keeps track of what portions of the document or documents will be printed and in what order. This allows a user to not only select what portions of the document or print job containing a number of documents but will also allow the user to control the sequence in which they are printed. It will also allow the user to automatically remove certain types of streams and streams of data or all pictures in JPG format or other formats.

The software will use concurrent programming formats that direct data streams into one or two processes for the files being controlled and printed (dual or quad core processors for one or two data streams) while the control file and external reference notation and control will likewise be placed on one or two data streams/processes depending on the number of processors. The code will be written in such a way that in a dual core computer the control files and external call files will occupy one core while the input and output data streams will be interleaved on the other. Quad core processors will split them into four streams or files. Single core processors or computers will interleave all four sections following normal procedures.

The third process is a method of accessing files online and on other remote locations so that they can be integrated into an existing print job while bypassing loading the information on the controlling computer and/or its hard drives. This means that the downloaded information is an exact hard copy of the files or information located on the Internet at a remote location or locations and it will be printed immediately so that there will be no opportunity to modify it by a third party.

The process and technique and its associated methods provide a method of accessing files and documents on the Internet and other remote locations and loading them directly into the print process so as to provide controllability and an unmodifiable hard copy which will provide an accurate rendition or copy of the online documentation for the purpose of scientific and legal citations as well as other purposes where references must be considered 100% accurate so in this process the references are immediately transferred from the Internet or other location directly to hard copy where the output can consist of the entire document with downloaded citations and information or it may consist of only the citations or information or it may be the portions of the document and citations and information chosen by the user. Therefore anyone using the printed information will be certain that the technical or legal information is not being modified as they are reading it which could happen with any other method of reading an online document.

This provides an extremely valuable resource for a number of processes such as peer review of scientific papers, students and scientists accessing information, and lawyers and judges citing legal precedents in motions and other court papers. The ability to have accurate information printed with the original document without having to go through the tedious location and downloading or copying from printed books of the separate reference and citation will be an extremely valuable asset for people needing information from electronically transmitted documents which use footnotes or endnotes

The citation method will also allow for a method of tracking such references through online software which will allow writers to receive allowable income as a result of using their copyrighted material as this patent process and technique will control tracking of the amount of downloaded information from a specific source both for copyright payment and to see whether entire documents under copyright are illegally downloaded and copied and possibly used in a manner exceeding the fair use doctrine of the copyright law. It would be an effective curb for illegal printing of books, newspapers, magazines, and all forms of documents and other reference material.

The software can then monitor the Internet to see whether the downloaded information (limited to that downloaded by the software covered in this patent) or major portions thereof appears on the Internet in such a manner, such as multiple copies being made available for free or sold when it would violate the copyright of a writer or organization.

The key difference between this software and software that merely downloads information to a computer where you can easily be modified before use is that an immediate hard copy is made before any person or software can intervene to modify the information. In other words, the information will not even temporarily reside on the base computer or any other computer but will be downloaded from the remote location or locations directly and immediately to the print spooler or printer.

There will also be a similar mode or process where the information normally sent through an e-mail that the sender and recipient wish to maintain security on can be transmitted via a remote online location and then to the recipient's computer where it is immediately printed in the same manner as described above and then removed immediately from the remote location or locations before it can be intercepted by unapproved third parties; the information is not even temporarily saved on the recipient's computer hard drives and the directly transmitted information would act merely as a trigger for the recipient's computer to begin a pre-described process or automatic protocol that will go to either a prearranged location or a location coded in the electronically transmitted information to download secure information to the printer/print spooler and then immediately delete it from the remote location or locations which will provide the recipient with a hard copy with an extremely high probability (almost certain) that the information was not intercepted.

The system could use a handshake protocol for more security where the recipient would have to send an acknowledgment back to the sender that it was ready for the information to be uploaded which would minimize the time the information was temporarily available at a remote location or locations. Even more security could be provided by either sending the information as a scan and/or breaking the message into several segments sent to several different locations. Coded or uncoated information may also be sent in the notifying e-mail and/or its return message that will provide information on the location where the tent information will be temporarily placed as part of the transmission process.

The key part is that the veracity of the information is provided only by a received and directly printed hard copy instead of digital local (except as provided for and controlled by this software that will have the ability to store information using a proprietary code in a manner and location not accessible by the operating system and file structure of the controlling computer due to proprietary techniques) and Internet files and information that is normally available for modification and copying by unauthorized organizations and individuals; examples range from private e-mails to scientific and engineering information and to sensitive legal documents as well as books and college paper references which may need some measure of security.

This patent also covers the several types of sequential or reverse printing formats as well as processing and transformation techniques to achieve the best uses of those formats. It also describes and outlines software designed to implement the process and transformation of documents, newspapers and books as well as adding secure reference information to documents, newspapers and books for the purpose of making sequential or reverse printing transformation techniques more useful and innovative.

It also covers transformation techniques and transformation processes to allow excerpts from other documents and e-books for the purpose of adding reference information to replace footnotes, endnotes and other reference information for the purpose of enhancing and easing the process of reading documents and books that commonly make references to previously written documents for additional support for an argument as well as other uses. The purpose is to add these footnote or endnote references to a document in their entirety so a reader does not have to physically find the referenced document to see what referenced information is contained in the referenced document.

Therefore the reference document transformation and addition process can be seen as two related but separate parts or processes in the patent claim. The first process involves all documents, newspapers and books utilizing automatic referencing of other document text added to print jobs that will become sequential or reverse print type print jobs for the purpose of replacing footnotes, in notes and other types of reference information. The second process refers to all documents, newspapers and books that are printed utilizing any current technique or process that utilizes the automatic referencing of other documents for the purpose of replacing footnotes in notes and other types of reference information.

The printing system described in this abstract modernizes the old-fashioned formats of printing currently used that date back to the beginning of printing. Double sided printing is still the preferred method for maximal use of materials. However, binding or fastening them together causes difficulties with reading one side of the bound document because of the curvature and wrinkling of the pages as they are turned in documents bound on the left (or right side, the left-hand (right hand) page is inherently difficult to read, especially in crowded situations. Documents bound at the top, while easier to read on one side in crowded situations, are invariably printed only on one side because they are even more difficult to read when printed on two sides using current techniques. There are also inherent problems with sheet feeders causing misregistration of two-sided documents using current techniques. All of these problems result in a great deal of wastage of paper and valuable time.

The software will also be able to use either dual core or quad core processing with dual core using two streams for everything (one file in one data stream) and quad core using two streams transforming and displaying the text portion of a print job and two streams tracking and displaying nonchangeable and non-modifiable JPEG files and read-only reference files from external sources. This will provide security for external references whose validity will be able to remain unchallenged by virtue of the fact that the user will not have access to it during the course of the print job.it will also allow side-by-side on-screen display of the print job both with and without JPEG files and external reference files. The user will have access to a wide variety of display formats and information on the file not normally available in text processing software. This software will be intended for and primarily aimed at providing the widest variety of print options that are available as part of the hardware options but are seldom immediately available to a user.

However, it is possible to print documents, using what is best described in this patent as sequential reverse printing, in such a manner that these difficulties are overcome. When added to software that allows real-time selection of what portions of the print job are actually printed combined with material that can be added from computer sources as well as real-time selection combined with real-time display of what the output printing job actually looks like, comprises a modern complete control of print jobs so as to utilize the capabilities of modern computing technology to print individual documents, newspapers, magazines and books in totally new formats utilizing the capabilities of computers.

One example would be ink availability based on previous usage and on best available knowledge of the amount of ink available in the cartridge both from measurement and knowledge of the previous ink used. It will also use a proprietary algorithm to provide a historical record and analysis of ink usage for a particular printer for the purpose of aiding ink usage estimates. It would also estimate and inform the user how many more pages are printable using the current document formats and how much a particular type of file inclusion would affect credibility amounts with the remaining ink. It would provide this information as part of the print display instead of requiring the user to guess at what the remaining ink is capable of printing.

This would help prevent the time and paper wasting as well as extremely frustrating experience of running out of ink in the middle of a print process. All of this valuable information is trivial and easily computable and displayable to the user. The reason it is not is that is part of the print job which is considered an afterthought to most software instead of an inherently valuable dimension in document processing. The software addresses that oversight and provides the user with a great deal of valuable information as part of the print job control software.

It could even tell users when it is time to take the toner cartridge out of the printer and shake it.

One possibility is effectively having a magazine printed in such a manner (horizontally instead of vertically) that when it is folded out, two “front pages” could be seen side-by-side and utilized for display purposes. It can be used for allowing the reader to start reading the document, magazine or book from either the beginning or the middle which could easily allow for interesting format possibilities, especially in the magazine and newspaper formats. For instance, a newspaper could start either with world news or by flipping it over, with the sports section.

Printing fan fold newspapers as one continuous sheet utilizing a reverse format would allow newspapers to be read without the immense amount of space currently required. This would also give a wider variety of formats to print pictures and text together in such a manner that the human eye may more easily and automatically perceive them as one entity. One example would be a fan fold newspaper where the front page started on one side of the first sheet and the sports page started on the other side would eat being read sequentially and alternately by flipping pages which would eliminate the tedious digging through a newspaper to find the correct section. Two other sections could be started at the opposite end of the fan fold newspaper and read towards the front page and sports section. It might be just the thing to shake up the moribund and shrinking newspaper publishing industry.

The output data from the program which is to be printed can be sent either directly to the print spooler or to a hardware/memory module made from flash memory and a microcontroller without extra program storage which is programmed to act as an extension of the main software controlling the print spooler when the print spooler runs out of storage memory. Its primary purpose is to act as a temporary storage when the print spooler is full and text is being downloaded directly from the Internet for direct printing. Therefore it is primarily a software operation which will allow a download to overwrite standard (not an Internet download) text from the computer program (the computer program will be informed of the overwrite and will resend the overwritten information after the downloaded text has been processed and printed. In the case of the download being so large as to not fit in the print spooler/intermediate memory module, a second call to the Internet download data (or as many as needed) will be made and the printing will start again at the point the memory module overflowed and this procedure will be repeated until the entire download has been printed. While this is hardly likely in reality (a 100 MB download can take a minute or more, while a 1 GB download would take 10,000 min. and a 16 GB download 160,000 min. or about 3000 hours), completeness of the program may require this ability or an equivalent limit on the size of the download as a possible option.

This patent comprises three separate sections, each of which has a variety of options to transform and process a print job.

The first section or module allows the user to select a number of files to be contained in the output print job folder. Additional files or e-books or portions of files or e-books contained either on the computer, a local network or an external library may be entered into a reference folder for future reference and usage within the text as explained below. This referenced information will only be used as allowed by law.

The difference is that files to be printed more or less in their entirety are placed in the output print job whereas files or e-books placed in the reference file are intended to have a small portion of the content added to the output print job as explained below.

Once the output print job folder is defined, it is sent to the second module for primary transformation and processing.

The second section comprises computer software that takes the output from the first module, splits it into two halves, reads each half into a three-dimensional algebraic matrix simulated in computer memory by an array of strings. Simple print jobs that require no additional processing at this point are then sent to the fourth module for output transformation, definition, additional typographical information and reverse print transformation and processing.

In multiprocessor computers, the two halves or sides of the print file will be processed independently and in parallel whenever possible. This will allow mathematical transformations and heuristics to reference other parts of the document from any point within the document. It will also save additional time in processing print jobs.

Print jobs requiring additional processing such as adding reference footnote or endnote information are then manipulated by computer software in the form of the control file which processes the three-dimensional algebraic matrix by using mathematical functions and heuristics to transform the content of the algebraic matrix into two highly variable data streams that can be printed or displayed for the convenience of the user. The system works primarily by creating a control file for the print job composed of starting points and stopping points, reference calls and other information controlling what is in the document matrix. The control file also reserved space for and creates calls to external files on another computer or external network location so that reference text pointed to by referenced calls which may be placed within the text as it is printed as the complete text of the call/download or dealt with in a manner chosen by the operator including storage in computer memory/auxiliary memory for later use or printed in a different location in the document being printed.

Location points including the size of the text to be embedded as read-only information may also be placed within the control file or within the document . . . . These are for downloads from off-line e-books and other reference material so that verified text can be placed within document materials for the purpose of convenient verification of references that will not have any doubt as to their validity and veracity. This will save an enormous amount of time for reviewers and readers of technical and legal materials who will not have to look up and verify footnotes, citations and other forms of reference.

The control file will begin printing the matrix which will be designated by standard I JKL vector indicators. The normal printing will proceed as a read-only operation until a look ahead designator sees the first reference in the control file indicating a change in that vector location whereupon it will make appropriate changes in the status of the print job going to the printer spooler/buffer for that location so that the printer sequence will take into account the new format for the print job from that point forward.

The control file will continue to be read and implemented until the complete document or documents have been printed or the midway point has been reached.

When using single-sided printers, the partially complete print job document will have to be reloaded into the feed tray so that the second side may be printed.

The third section comprises computer software that transforms the output of the previously mentioned computer software into a output format that can be can be conveniently displayed in order to provide user interaction into the final process and transformation product that can be printed or displayed. The purpose of this section is to allow the user to make changes and corrections to the output product that will then be fed back to the input of the above computer software and then immediately process and rippled through to be correctly displayed as modified by the user in real-time.

One method of using this is to display text pages using different color and shades of print as indicated by the user so as to give the user a real-time display of contrast and readability. Color histograms can also be displayed to give an idea of increased and lowered histograms on each side of the selected level.

Pages of text and pictures can be printed and scanned as a test page to enable precise control of density and contrast.

The first section covers several new output formats for printing documents including newspapers. The new formats transform the output from computer programs, especially personal computer programs, into several new formats which are significantly more convenient for a reader who wants to use printer output that is printed on both sides of a single sheet or multiple sheets of paper. A second version of the output format is applicable to printing on continuous sheets of paper on both sides in a format that makes the output more convenient to read.

The cost of printing the document can also be estimated. It will also be part of the software to estimate what the cost savings would be by manipulating the print job in certain ways. One example would be to estimate the cost savings by removing all JPEG files from the output document. Another would be to estimate a per page cost which would be displayed next to each column page as it is displayed on the screen. Cost savings by changing color to black-and-white printing and even the cost savings based on changing the darkness and contrast in relation to certain types of paper so that a person may decide whether to use a high sheen, high contrast or less expensive type of paper.

One output format is used to print a file in a new format or formats called reverse printing. The primary difference in these is the location of a sequence of pages that are printed on both sides of sheet fed printers. Normally these are printed as if they were in a bound book. However, in a single-sided sheet fed printer that has a propensity to the two sheets or more at a time during the second half of the printing cycle especially with freshly printed pages that tend to stick together, meeting two pages will cause a print discrepancy causing a misalignment in the correct sequence of printing so that pages are offset from their correct location requiring a reprint of all or part of the print job. The reverse printing format which prints in a total sequence rather than a page by page format obviates the problem because skipped pages simply turn up as blank pages in the sequence simply continues from the next page so that it is still able to be read in sequence.

The reverse printing format is split into several formats labeled as sequential or reverse book format, sequential or reverse flip format and sequential or reverse fan fold printing.

Sequential or reverse book format is printed by printing the first half of the print job in sequence with by numbers rounded up to the next highest even-numbered page and printed in sequence. The second half of the print job is printed upside down starting with the backside of the last printed being the first page of the second half of the print job and the backside of the beginning page or pages being the last page of the second half of the print job. The resulting package is then fastened (usually stapled) on one side (the longest side) with an optional folder (Pendaflex or equivalent) added to the print job for stiffening and protection as often normally. The result is a document that can be conveniently read one page at a time in sequence in one direction (obviating the problem of trying to read a left-hand page that is inconveniently curved and difficult to read) at the end of the first half of the document, the document is closed, turned vertically to the opposite side in the same easy read is available for the second half of the document. This makes the document easy read because only one page of the two available is read at once. It is also immediately obvious that as mentioned previously, two or more pages that are fed together simply result in a blank page (or pages) that are skipped over with no loss of continuity or missing pages. The result is a method of printing two-sided documents without the chaos and waste of time and materials resulting from misregistration

In a similar manner, documents fastened at the top cannot be printed on two sides and easily read. The new printing method is almost identical to the previous method. The only exception is that the pages are not reversed in the vertical sense but are simply printed in a reverse sequence. This allows the user to read one side of the page in sequence until the halfway point where the document is closed, turned horizontally whereupon it can continue to be read in sequence by flipping the pages vertically. This method is extremely convenient for crowded situations without the wastage of paper and doubling of the thickness of the document with single-sided printing. Considering the difficulty of reading documents on an aircraft, this could be extremely important. It could even factor into the size of briefcases and other luggage brought into an aircraft where it is becoming more and more difficult to bring sufficient baggage along on a trip.

The new document has a process to make reading easier people with hand problems who have difficulty reading conventionally printed and bound documents, newspapers, this and books. A document printed in sequential or reverse format and fastened at the bottom and placed in an appropriate rack or control mechanism would allow a handicapped person to turn pages with minimal effort and then have the control mechanism reset and flip the document so the reader can go through the entire document with minimal effort. Reading documents in this format would be easier for people who either have minimal use of their hands or have had limbs replaced with prosthetic appliances with resulting improvement in their lifestyle.

The result of the new formats for printing and reading documents and other material and the software transforming and producing the new formats is to produce material that is physically easier to read and understand in the context of modern technological life. At least one of the formats allows two-sided documents to be conveniently read in situations where a traditional book format or newspaper format would be inconvenient. The new formats also provide a solution to the difficulty of reading the left-hand page of traditional two-sided format printing used in books, documents and newspapers. Furthermore, printing difficulties and errors are alleviated or removed entirely with the consequent savings of time and money. The new formats and the new printing control software represent a significant step forward in an area of computer technology that is previously been almost entirely ignored.

This patent claim covers a method of controlling the formatting and handling of the process of printing documents, books, and newspapers including new methods of laying out documents so that they are easier to read while reducing the usage or wastage of paper and printing supplies as well as reducing associated costs and in addition, it introduces a significant new method of securely and accurately handling the downloading of all types of references, footnotes, endnotes, and the content of e-mails so that the information is printed immediately and therefore can be considered as secure and accurate renditions of the information downloaded from online and other locations.

1. I claim that the new formats introduce a sequential method of printing documents on computer-controlled printers, especially personal computers so that the first half of the document is printed in numeric sequence one side of one or more sheets of paper and the second half of the document is printed in reverse sequential order on the reverse side of the sheets of paper or papers.

2. I claim that style a prints the second half of the document with the same sense as the first half and is fastened at either the top or the bottom which produces a document that is read in sequence on one side and then turned horizontally to continue reading in sequence on the second side while style b prints the second half of the document with the opposite sense as the first half and is fastened at either the right or left side which produces a document that is read in sequence on one side and then flipped vertically to continue reading in sequence on the second side.

3. I claim that both styles (a and b) and variations of them can be printed in either vertical portrait mode or and horizontal landscape mode which provides a variety of formats which is especially useful for printing and reading certain types of documents such as newspapers and magazines and some documents such as newspapers can be printed on continuous sheets of paper in a fan fold format using either style a or style b which provide a completely different way of printing and reading newspapers, pamphlets and magazines.

4. I claim that the sequential reverse printing method provides an easy way to print random pages of a document or documents in a condensed format on both sides of printed sheets of paper and that it provides a method of printing documents that potentially reduces the number of pages printed for a document or series or groups of documents by improving the methods available for two-sided printing.

5. I claim that the sequential reverse printing method (hereafter srp) provides a method of printing documents that reduces the chances of operator error in the printing of two-sided documents and that this method of controlling the printing of a document or documents allows an operator or user to print pages or parts of pages of an input document or documents in any sequence so as to facilitate the creation of a single output document as specified by the user and using the minimum amount of paper.

6. I claim that SRP process and techniques provide a method for controlling and modifying the features and parameters of the output file so that it will be printed using the desired colors, density of print, and other related features

7. I claim that this method of printing uses a separate file to control the printing out a document or group of documents as part of the print job the print file will directly input and use operator commands using the standard or custom control methods available to the user of a computer being used to control the printing of a document or group of documents as a print job and that the print job control file can be edited directly so as to facilitate control of the printing process of more than one similar print job

8. I claim the process and technique and its associated methods provide a method of accessing files and documents on the internet and other remote locations and loading them directly into the print process or secure storage location which will provide controllability and an unmodifiable hard copy that will provide an accurate rendition or copy of the online documentation or other information for the purpose of scientific and legal citations as well as other purposes where references must be considered 100% accurate so in this process the references are immediately transferred from the internet or other location directly to hard copy or, using proprietary data formats, can be written to and on storage location that are not accessible by the computer file system or other search tools because they appear to be random data instead of an organized file where the output can consist of the entire document with downloaded citations and information or it may consist of only the citations or information or it may be the portions of the document and citations and information chosen by the user.

9. I claim that this provides an extremely valuable resource for a number of processes such as peer review of scientific papers, students and scientists accessing information, and lawyers and judges citing legal precedents in motions and other court papers as the ability to have accurate information printed with the original document without having to go through the tedious location and downloading of the separate reference and citation will be an extremely valuable asset for groups ranging from students to judges to lawyers to professors to everyday readers where electronically transmitted documents which use footnotes or endnotes can have them downloaded for the benefit of the professor, student, or other reader.

10. I claim that the citation method will also allow for a method of tracking such references through online software which will allow copyright owners to receive copyright or other income as a result of using their copyrighted material as this patent process and technique will control tracking of the amount of downloaded information from a specific source both for copyright payment and to see whether entire documents under copyright are illegally downloaded and copied and possibly used in a manner exceeding the fair use doctrine of the copyright law.

11. I claim that the software can then monitor the internet to see whether the downloaded information or major portions thereof appears on the internet in such a manner, such as multiple copies being made available for free or sold when it would violate the copyright of a writer or organization.

12. I claim that the key difference between this software and software that merely downloads information to a computer where it can easily be modified before use is that an immediate hard copy is made before any person or software can intervene to modify the information; in other words, the information will not even temporarily reside on the base computer or any other computer but will be downloaded from the remote location or locations directly and immediately to the print spooler or printer.

13. I claim that there will also be a similar mode or process where the information normally sent through an e-mail that the sender and recipient wish to maintain security on can be transmitted via a remote online location and then to the recipient's computer where it is immediately printed in the same manner as described above and then removed immediately from the remote location or locations before it can be intercepted by unapproved third parties; the information is not even temporarily saved on the recipient's computer hard drives and the directly transmitted information would act merely as a trigger for the recipient's computer to begin a pre-described process or automatic protocol that will go to either a prearranged location or a location coded in the electronically transmitted information to download secure information to the printer/print spooler and then immediately delete it from the remote location or locations which will provide the recipient with a hard copy with an extremely high probability (almost certain) that the information was not intercepted due to the short time it actually exists as an electronic or digital document because even a directly monitoring process requires a finite amount of time to decide whether to intercept and copy any particular block of data.

14. I claim that the system will have the ability to use a handshake protocol for more security where the recipient would have to send an acknowledgment back to the sender that it was ready for the information to be uploaded which would minimize the time the information was temporarily available at a remote location or locations, Even more security could be provided by either sending the information as a scan and/or breaking the message into several segments sent to several different locations.

15. I claim that key part is that the accuracy of the information is provided by a received and printed hard copy instead of digital local (except as secured by this software) and Internet files and information that is its available for copying and modification by unauthorized people and groups; examples range from private e-mails to scientific and engineering information and to sensitive legal documents as well as books and college paper references which do not need security

16. I claim that the citation method herein described as part of this patent will also allow for a method of tracking downloaded references through part of the software described in this patent which will allow writers to receive allowable income as a result of using their copyrighted material as this patent process and technique will control tracking of the amount of downloaded information from a specific source both for copyright payment and to see whether entire documents under copyright are illegally downloaded and copied and possibly used in a manner exceeding the fair use doctrine of the copyright law. It would be an effective curb for illegal printing of books, newspapers, magazines, and all forms of documents and other reference material.

17. I claim that the software described in this patent can then monitor the Internet to see whether the downloaded information (limited to that data or information downloaded, manipulated, or controlled by the software covered in this patent) or major portions thereof appears on the Internet in such a manner, such as multiple copies being made available for free or sold when it would violate the copyright of a writer or organization which is using the software described in this patent and as such would provide a useful tool for the owners and users of this software for protection of their copyright claims.

18. I claim that the formats can only be used for formatting documents as provided and controlled by this patent and applicable patent law and this patent covers the usage of these formats under any circumstances including on the Internet including blogs, webpages, cloud computing or storage locations and Internet pages or other locations which use the formats either as part of their internal structure or as an output including Internet transmission of data and printed output.

19. I claim that the software will have the ability to automatically or manually highlight or remove parts of the document indicated by the operator based on the ink density and the expense of printing that part of the document and will create a display (either at the document location or in a separate file based on operator input or default status) showing the person what is being removed based on actual printing costs while allowing the operator to make minor changes such as removing background shading and changing high density printing or intense colors to less expensive options at the option of the operator in order to make printing, especially multiple copies, economically feasible so that that portion of the document can be placed back in the document at the choice of the operator.

20. I can claim the fan fold printing using Style One or Style Two formats can be used for printing newspapers, magazines, or other documents in a useful process and technique that allows either two or four of the traditional newspaper sections or magazine sections to begin at either end of the fan fold printed document so that a reader can begin any of the sections at one end of the document and read it sequentially and easily by simply flipping the pages of the document in sequence; the examples of fan fold printing will make the printing style clear as it is difficult to briefly describe it in writing.

21. I claim that this software will be able to translate and reformat existing footnotes, and notes, and other reference calls in all forms of online books, magazines, documents, and technical and scientific papers into a standard format that will allow the software to download information as previously mentioned in several claims for the purpose of providing an innovative and accurate source of information to researchers, teachers, students, and all citizens in a standard format that will allow the software to provide actual reference information instead of just footnotes, endnotes, or other submissions.

22. I claim that the software can also be used on a microcontroller or computer that resides in a printer that can utilize a portion of the software or the entire software product in such a manner (without a typical computer operating system or file system) that it allows a direct connection to the Internet for the purpose of downloading secure information directly to a printer or printer spooler for the purpose of immediate printing of secure or private information or directly to a storage medium as defined in claims 13, 14, and 15.
